(19) United States
(12) Patent Application Publication
(10) Pub. No.: US 2004/0083117 A1
(43) Pub. Date: Apr. 29, 2004

(54) Method for fast searching and analyzing inter-relations between patents from a patent database

(76) Inventors: Il-Soo Kim, Seoul (KR); Se-Chang Han, Kyoggi-do (KR); Ji-Rak Jung, Seoul (KR); Sik Choi, Kyonggi-do (KR)

Correspondence Address: Paul J Farrell, Dilworth & Barrese, 333 Earle Ovington Blvd, Uniondale, NY, 11553, US

(21) Appl. No.: 10/398,050

(22) PCT Filed: Mar. 11, 2002
(86) PCT No.: PCT/KR02/00414

(30) Foreign Application Priority Data
Aug. 1, 2001 (KR) 2001/46564

(51) Int. Cl. G06F 17/60

(52) U.S. Cl. 705/1; 707/104.1

(57) ABSTRACT

This invention relates to a method for fast searching and analyzing inter-relations between patents associated with a target patent from a patent database having information on issued patents of United States and published European patents and creating a citation relation diagram. Especially, this invention is characterized by a method of creating a patent relation table through inter-relation between patents, classifying the data stored in the table into many independent folders by using a specific Hashing function and storing the classified data into the independent folders in the form of computer files.

### BACKGROUND OF THE INVENTION

1. Field of the Invention

This invention relates to a method for fast searching and analyzing inter-relations between patents associated with a target patent from a patent database having information on issued patents of United States and published European patents and creating a citation relation diagram.

Especially, this invention is characterized by a method of creating a patent relation table through inter-relation between patents, classifying the data stored in the table into many independent folders by using a specific Hashing function and storing the classified data into independent folders in the form of computer files.

2. Description of the Related Arts

So far, prior patent searching systems have used to create a patent relation table in order to find inter-relation between patents by searching inter-relations between patents from ‘Reference cited’ information stored in a prior art patent database and repeat the patent relation table many times. Therefore, it takes too much time to search and analysis the inter-relation between patents.

### SUMMARY OF THE INVENTION

The present invention was devised to solve the above-noted problems.

And the object of the present invention is to provide a fast searching method capable of dramatically reducing searching time by adapting a method for creating a patent relation table through inter-relation between patents, classifying the data stored in the table into many independent folders by using a specific Hashing function and storing the classified data into independent folders in the form of computer files.

### BRIEF DESCRIPTION OF THE DRAWINGS

The object, other features and advantages of the present invention will become more apparent by describing the preferable embodiment thereof with reference to the accompanying drawings, in which:

FIG. 1 illustrates a patent relation table as an embodiment of the present invention.

FIG. 2 is a form of a split file created by the present invention when the Hashing function is defined by the position of decimal points of an issued patent of the United States.

FIG. 3 is a form of a Backward file created by the present invention when the Hashing function is defined by the position of decimal points of an issued patent of the United States.

### DESCRIPTION OF THE PREFERRED EMBODIMENTS

This invention is a method for fast searching and analyzing inter-relations between patents associated with a patent (hereinafter, which is called to a ‘Target Patent’) from a patent database (hereinafter we call it ‘General Prior Patent Database’) having patent number information on citing patents (hereinafter we call it ‘Reference Cited’) at the time of application of the target patent and for creating diagrams indicating their patent relations (hereinafter, we call it ‘Relation Diagram’).

The method according to the present invention comprises the following steps.

That is, a step for inputting at least one patent number (hereinafter we call it ‘Patent Number’) of the Target Patent among of application number, published number (laid-opened number) and issued number,

a step for searching prior patents including the Target Patent as a prior patent (hereinafter we call it ‘Direct Related Patent’) in the Reference Cited field in the General Prior Patent Database and a step for searching repeatedly direct relating patents for each the searched Direct Related Patent (hereinafter we call it ‘Indirect Related Patent’ to the Target Patent) in order to analyze relations between the Target Patent and patents cited by the Target Patent at the time of application (hereinafter we call it ‘Backward Patent’),

a step for creating a citation relation table having two columns which comprise a regularly ordered patent number column (hereinafter we call it ‘the first column’) by using the searching result and a Backward patent number column for each patent number in the first column (hereinafter we call it ‘the second column’),

a step for creating independent folders in a directory by a Hashing function having patent numbers in the first column as parameters defined by user wherein each folder saves split files classified by the defined Hashing function within predetermined numbers,

a step for classifying each patent number in the first column into the independent file and then saving each split file to appropriate folder classified by the Hashing function wherein each split file saves all patent numbers in the second column having a same row to each patent number in the first column (that is, all patent numbers cited by any patent number at the time of application are saved in the split file),

a step for creating independent folders in another directory by a Hashing function having patent numbers in the first column as parameters defined by user wherein each folder saves the Backward files classified by the defined Hashing function within predetermined numbers,

a step for reading split files with ascending order from a split file having the oldest patent number and creating a Backward file data comprising pairs of patent number in the first column associated with its split file and patent number (Backward Patent) in the second column having same row to the associated patent number,

a step for determining whether any pair of Backward file data associated to the patent number of the Backward Patent among the Backward file data group is already created to other Backward file data,

if already created, a step for reading the created Backward file data in other Backward file and adding the read Backward file data into its own Backward file data,

a step for determining whether identical Backward file data are existed in a Backward file and stopping the adding step if existed or adding to the Backward file data if not existed,

a step for creating a Backward file after adding the created and added Backward file data and creating all Backward files by repeating the above steps, and

a step for sending the split files and Backward file to a graphic software and making Relation Diagrams.

On the other hand, a method for searching and analyzing prior patents citing an inputted Target Patent at the time of application according to the present invention comprises the following steps.

That is, a step for inputting at least one patent number (hereinafter, which is called to a ‘Patent Number’) of the Target Patent among of application number, published number (laid-opened number), and issued number,

a step for searching prior patents (hereinafter we call it ‘Direct Related Patent’) including the Target Patent in the Reference Cited field in the General Prior Patent Database and a step for searching repeatedly direct relating patents for each the searched Direct Related Patent (hereinafter we call it ‘Indirect Related Patent’ to the Target Patent) in order to analyze relations between the Target Patent and patents citing the Target Patent at the time of application (hereinafter we call it ‘Forward Patent’),

a step for creating a citation relation table having two columns which comprise a regularly ordered patent number column (hereinafter we call it ‘the first column’) by using the searching result and a Forward patent number column for each patent number in the first column (hereinafter we call it ‘the second column’),

a step for creating independent folders in a directors by a Hashing function having patent numbers in the first column as parameters defined by user wherein each folder saves split files classified by the defined Hashing function within predetermined numbers,

a step for classifying each patent number in the first column into the independent file and then saving each split file to appropriate folder classified by the Hashing function wherein each split file saves all patent numbers in the second column having a same row to each patent number in the second column (that is, all patent numbers citing its own patent number at the time of application are saved in the split file),

a step for creating independent folders in another directory by a Hashing function having patent numbers in tine first column as parameters defined by user wherein each folder saves the Forward files classified by the defined Hashing function within predetermined numbers,

a step for reading split files with descending order from a split file having the most recent patent number and creating a Backward file data comprising pairs of patent number in the first column associated with its split file and patent number (Forward Patent) in the second column having same row to the associated patent number,

a step for determining whether any pair of Forward file data associated to the patent number of the Forward Patent among the Forward file data group is already created to other Forward file data,

if already created, a step for reading the created Forward file data in other Forward file and adding the read Forward file data into its own Forward file data,

a step for determining whether identical Forward file data are existed in a Forward file and stopping the adding step if existed or adding to the Forward file data if not existed,

a step for creating a Forward file after adding the created and added Forward file data and creating all Forward files by repeating the above steps, and

a step for sending the split files and Forward file to a graphic software and making Relation Diagrams.

As an embodiment, if the Hashing function is defined by the position of decimal point of a patent number, it is preferable to create folders named of patent numbers which parts of it are deleted from the end and to save files in the created each folder having number of files within numbers of the deleted numbers.

And it is possible whether a Hashing function to classify split files and a Hashing function to classify Backward or Forward files are defined with same definition or not.

In the following, an embodiment is shown for more understanding with reference to drawings. In this embodiment, analyzing process for Backward patent is executed by through the U.S. Patent Database and the Hashing function is defined by the position of decimal points of a patent number and folder names are defined by patent numbers which parts of it are deleted from the end.

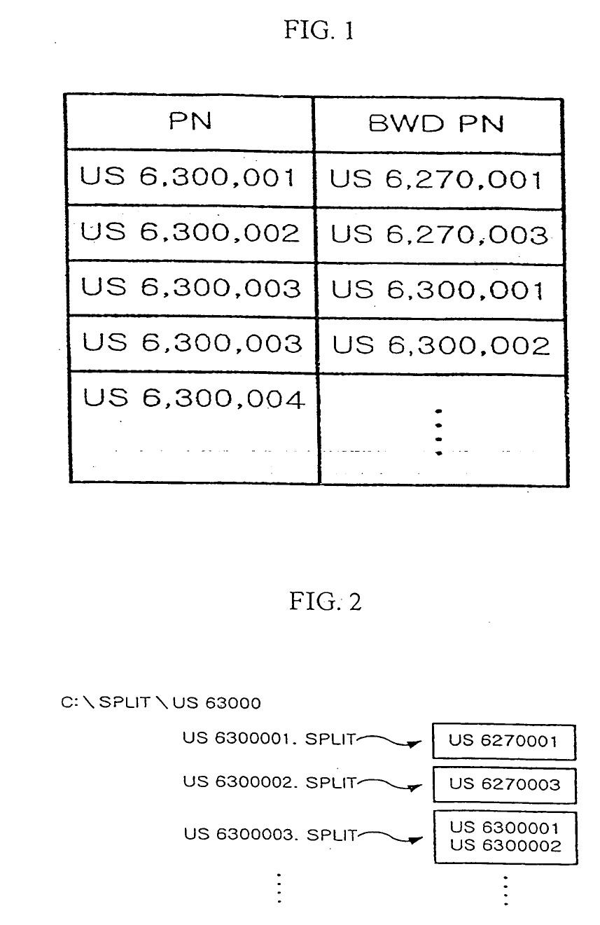

FIG. 1 illustrates a citation relation table including a column or regularly ordered patent numbers (the first column) and a column having Backward patent numbers for each patent number in the first column (the second column).

As shown in the citation relation table of the FIG. 1, the U.S. Pat. Nos. 6,300,001 and 6,300,002 respectively cited the U.S. Pat. Nos. 6,270,001 and 6,270,003 at the time of application, and the U.S. Pat. No. 6,300,003 cited the U.S. Pat. Nos. 6,300,001 and 6,300,002 at the time of application.

FIG. 2 illustrates a form of a creating split file in case of the Hashing function is defined by the position of decimal points of an issued patent of the United States. That is, firstly, creating independent folders under the C:\directory after deleting two digits of the patent numbers in the first column from the end (for example, the folder name is US63000 in case of U.S. Pat. No. 6,300,001) and secondly, making 100 split files in each folder (in this case, the names of split files are US6300000, . . . , US6300099) and finally, saving Backward patent numbers in each split file for appropriate patent numbers associated with appropriate split file.

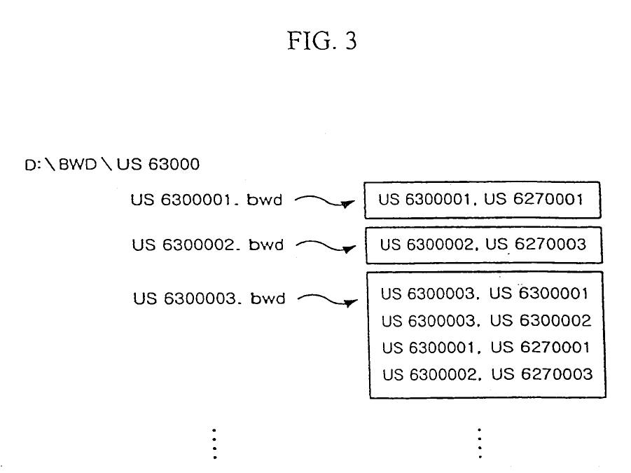

FIG. 3 illustrates a form of a creating Backward file in case of the Hashing function is defined by the function of FIG. 2.

That is, firstly, creating independent folders under the D:\directory after deleting two digits of the patent numbers in the first column from the end (for example, the folder name is US63000 in case of U.S. Pat. No. 6,300,001) and secondly, making 100 Backward files in each folder (in this case, the names of Backward files are US6300000, . . . , US6300099).

And then, after reading split files with ascending order from a split file having the oldest patent number, creates a Backward file data comprising pairs of patent number in the first column associated with its split file and patent number (Backward Patent) in the second column having same row to the associated patent number.

At this time, after determining whether any pair of Backward file data associated to the patent number of the Backward Patent among the Backward file data group is already created to other Backward file data, reads the created Backward file data in other Backward file and adds the read Backward file data to its own Backward file data if already created.

Also, after determining whether identical Backward file data are existed in a Backward file, stops the adding step if existed or add to the Backward file data if not existed. In the same manner, creates a Backward file after adding the created and added Backward file data and creates all Backward files by repeating the above step.

The Backward file data for each Backward file according to this embodiment is as bellows.

That is, a Backward file data for US6300001 is (US6300001, US6270001) and a Backward file data for US6300003 is (US6300003, US6300001/US6300003, US6300002/US6300001, US6270001/US6300002, US6270003).

A Relation Diagrams is created by sending the split files and Backward file to a graphic software.

As the searching way for the Forward patent is similar to the Backward's except executing from the most recent patent number, the detail explanation for the Forward patent shall be omitted.

Due to this present invention, it is possible to dramatically reduce searching time by adapting a method for creating a patent relation table through inter-relation between patents, classifying the data stored in the table into many independent folders by using a specific Hashing function and storing the classified data into computer memory in the form of computer files.

What is claimed is:

1. A method for fast searching and analyzing inter-relations between patents associated with a patent (hereinafter we call it ‘Target Patent’) from a patent database (hereinafter we call it ‘General Prior Patent Database’) having patent number information on citing patents (hereinafter we call it ‘Reference Cited’) at the time of application of the target patent and for creating diagrams indicating their patent relations (hereinafter we call it ‘Relation Diagram’) said method comprising the steps of:
a step for inputting at least one patent number (hereinafter we call it ‘Patent Number’) of the Target Patent among of application number, published number (laid-opened number) and issued number; and
a step for starching prior patents including the Target Patent as a prior patent (hereinafter we call it ‘Direct Related Patent’) in the Reference Cited field in the General Prior Patent Database and a step for searching repeatedly direct relating patents for each the searched Direct Related Patent (hereinafter we call it ‘Indirect Related Patent’ to the Target Patent) in order to analyze relations between the Target Patent and patents cited by the Target Patent at the time of application (hereinafter we call it ‘Backward Patent’);
a step for creating a citation relation table having two columns which comprise a regularly ordered patent number column (hereinafter we call it ‘the first column’) by using the searching result and a Backward patent number column for each patent number in the first column (hereinafter we call it ‘the second column’);
a step for creating independent folders in a directory by a Hashing function having patent numbers in the first column as parameters defined by user wherein each folder saves split files classified by the defined Hashing function within predetermined numbers;
a step for classifying each patent number in the first column into the independent file and then saving each split file to appropriate folder classified by the Hashing function wherein each split file saves all patent numbers in the second column having a same row to each patent number in the first column (that is, all patent numbers cited by any patent number at the time of application are saved in the split file);
a step for creating independent folders in another directory by a Hashing function having patent numbers in the first column as parameters defined by user wherein each folder saves the Backward files classified by the defined Hashing function within predetermined numbers;
a step for reading split files with ascending order from a split file having the oldest patent number and creating a Backward file data comprising pairs of patent number in the first column associated with its split file and patent number (Backward Patent) in the second column having same row to the associated patent number;
a step for determining whether any pair of Backward file data associated to the patent number of the Backward Patent among the Backward file data group is already created to other Backward file data;
if already created, a step for reading the created Backward file data in other Backward file and adding the read Backward file data into its own Backward file data;
a step for determining whether identical Backward file data are existed in a Backward file and stopping the adding step if existed or adding to the Backward file data if not existed;
a step for creating a Backward file after adding the created and added Backward file data and creating all Backward files by repeating the above steps;
a step for sending the split files and Backward file to a graphic software and making Relation Diagrams.

2. A method for fast searching and analyzing inter-relations between patents associated with a patent (hereinafter we call it ‘Target Patent’) from a patent database (hereinafter we call it ‘General Prior Patent Database’) having patent number information on citing patents (hereinafter we call it ‘Reference Cited’) at the time of application of the target patent and for creating diagrams indicating their patent relations (hereinafter we call it ‘Relation Diagram’) said method comprising the steps of:
a step for inputting at least one patent number (hereinafter we call it ‘Patent Number’) of the Target Patent among of application number, published number (laid-opened number) and issued number; and
a step for searching prior patents (hereinafter we call it ‘Direct Related Patent’) including the Target Patent in the Reference Cited field in the General Prior Patent Database and a step for searching repeatedly direct relating patents for each the searched Direct Related Patent (hereinafter we call it ‘Indirect Related Patent’ to he Target Patent) in order to analyze relations between the Target Patent and patents citing the Target Patent at the time of application (hereinafter we call it ‘Forward Patent’);
a step for crating a citation relation table having two columns which comprise a regularly ordered patent number column (hereinafter we call it ‘the first column’) by using the searching result and a Forward patent number column for each patent number in the first column (hereinafter we call it ‘the second column’);
a step for creating independent folders in a directory by a Hashing function having patent numbers in the first column as parameters defined by user wherein each folder saves split files classified by the defined Hashing function within predetermined numbers;
a step for classifying each patent number in the first column into the independent file and then saving each split file to appropriate folder classified by the Hashing function wherein each split file saves all patent numbers in the second column having a same row to each patent number in the second column (that is, all patent numbers citing its own patent number at the time of application are saved in the split file);
a step for creating independent folders in another directory by a Hashing function having patent numbers in the first column as parameters defined by user wherein each folder saves the Forward files classified by the defined Hashing function within predetermined numbers;
a step for reading split files with descending order from a split file having the most recent patent number and creating a Backward file data comprising pairs of patent number in the first column associated with its split file and patent number (Forward Patent) in the second column having same row to the associated patent number;
a step for determining whether any pair of Forward file data associated to the patent number of the Forward Patent among the Forward file data group is already created to other Forward file data;
if already created, a step for reading the created Forward file data in other Forward file and adding the read Forward file data into its own Forward file data;
a step for determining whether identical Forward file data are existed in a Forward file and stopping the adding step if existed or adding to the Forward file data if not existed;
a step for creating a Forward file after adding the created and added Forward file data and creating all Forward files by repeating the above steps;
a step for sending the split files and Forward file to a graphic software and making Relation Diagrams.

3. The method as set forth in claim 1 or 2, wherein, if the Hashing function is defined by the position of decimal point of a patent number, said method is characterized by creating folders with names of patent number deleted part of patent numbers from the end and saving files in the created each folder having number of files within numbers of the deleted numbers.

4. The method as set forth in claim 1 or 2, wherein the Hashing function to classify split files and the Hashing function to classify Backward or Forward files are defined with same definition.

5. The method as set forth in claim 1 or 2, wherein the Hashing function to classify split files and the Hashing function to classify Backward or Forward files are not defined with same definition.
